(19) United States
(12) Patent Application Publication
(10) Pub. No.: US 2003/0069806 A1
(43) Pub. Date: Apr. 10, 2003

(54) System and method for sharing needs and information using physical entities

(76) Inventor: Shin?apos;ichi Konomi, Ohnojo-Shi (JP)

Correspondence Address: THE LAW FIRM OF HARRIS & BURDICK, HAROLD BURDICK AND ROBERT HARRIS, 6676 GUNPARK DRIVE, SUITE E, BOULDER, CO, 80301

(21) Appl. No.: 10/264,660

(22) Filed: Oct. 5, 2002

(30) Foreign Application Priority Data
Oct. 8, 2001 (JP) 2001-346759

(51) Int. Cl. G06F 17/60

(52) U.S. Cl. 705/26

(57) ABSTRACT

A system and method that allows for attaching users' needs descriptions to physical entities including physical objects and physical spaces, sharing the attached needs descriptions, and obtaining needed information easily according to users' situations. The system and method are provided for enabling sharing of needs objects using physical entities where the needs objects contain needs descriptions, to make it possible to easily create needs descriptions and information descriptions by utilizing existing needs descriptions and information descriptions, for notifying users of all or part of a created needs description or a created information description, and for gathering information descriptions related to needs descriptions by either gathering automatically from information sources on the network of by sending the needs objects to other users.

### BACKGROUND

1. Field of Invention

This invention relates to sharing of information using devices that have computing capabilities, specifically to systems and methods for sharing information and needs that are associated with physical entities.

2. Description of Prior Art

In recent years, distributed computers can share information via wired as well as wireless computer networks where the shared information is stored on storage systems such as file systems and database systems.

Also, mobile devices such as notebook computers, handheld computers and PDAs (personal digital assistants) are pervading in our society.

Users of mobile devices can share information at various indoor and outdoor locations using said mobile devices and said computer networks where the shared information is stored on storage systems such as file systems and database systems.

Furthermore, it is possible to share information related to physical entities including physical spaces and physical objects using location information obtaining procedures involving the global positioning system (GPS) or using sensors including radio frequency identification (RFID) readers and barcode scanners. However, existing methods only provides the functionality to directly attach said information to physical entities.

A similar functionality is proposed in unexamined JP patent application 09-128310. The method described in this application attaches specified information to physical objects or physical spaces, and allows a local and a remote computer to share said information. However, this method does not allow for storing or sharing of knowledge on needs and specifications that said information attached by users is based on.

### SUMMARY

Existing technologies for information sharing using physical entities only provide functionalities for directly attaching information to physical objects and physical spaces. Therefore, there exists a problem that knowledge on users' needs that said attached information is based on, is not shared and lost.

If a single information piece is directly attached to a physical entity, said information piece is always presented to all users in relation to said physical entity. Therefore, there exists a problem of being unable to deal with cases where each user needs different information or information needed by a user changes according to time and situations. Also, if many information pieces are attached to a physical entity, there is a problem of difficulty to search needed information form the attached information pieces.

Also, there exists a problem of difficulty to use systems if users do not clearly know what information they need or do not know methods to specify needed information.

The object of this invention, which is performed in consideration of the above respects, is to provide systems and methods that allow for attaching users' needs descriptions to physical entities by using computer networks and mobile devices, and also allow for processing and sharing of the needs descriptions.

The provision of said systems and methods makes it possible to first reference needs descriptions and then selectively use information of interest even when many information pieces are attached to a physical entity.

Also, the provision of said systems and methods allow the systems to support users to use the systems easily even when the users do not clearly know what information they need or do not know methods to specify needed information. Such support is enabled by presenting the users stored and shared needs descriptions and by permitting modifications and registrations of the presented needs descriptions.

Note that the words physical entities are used in this specification to denote physical objects, humans, animals, plants, geographic locations and areas, and any other entities that have physical presence.

To solve the above problems, this invention provides needs sharing systems and methods for sharing needs objects via physical entities where the needs objects contain needs descriptions.

Specifically, first, if at least one physical entity is presented to a mobile device or a computer, the needs sharing systems use an identification information obtaining procedure for acquiring identification information of a physical entity and obtain identification information of said physical entity. Next, if there is at least one needs object that is associated with the identification information of said physical entity, the needs sharing systems use a needs display procedure for displaying needs objects associated with physical entities and display the needs object on said mobile device or said computer. Furthermore, if at least one of said displayed needs objects is selected and at least one information object contains an information description that is associated with the selected needs object, the needs sharing system use an information display procedure for displaying information objects associated with needs descriptions and display the information object on said mobile device or said computer. In addition, a newly created needs description can be attached to said physical entity by using a needs association procedure for attaching needs objects to identification information of physical entities. Furthermore, a newly created information description can be attached to said selected needs description by using an information association procedure for attaching information objects to needs objects.

Also, a system and a method for facilitating creation of needs descriptions and information descriptions by using existing needs descriptions and information descriptions are separately provided according to this invention.

Also, a system and a method for directly associating information descriptions to physical entities without needs objects and allowing users to share the attached information descriptions are separately provided according to this invention. The system and the method use a direct information association procedure for directly associating information objects with physical entities and a direct information display procedure for displaying information objects that are associated with physical entities by using the direct information association procedure.

Also, a system and a method for allowing users to utilize needs objects and information objects related to a physical entity even if said physical entity does not exist near a mobile device or a computer are provided separately according to this invention. The system and the method are capable of allowing users to utilize the objects if said physical entity has been recognized by the needs sharing systems.

Also, a system and a method for sending all or part of a created needs object or a created information object is provided separately according to this invention. The system and the method use a notification procedure for notifying needs objects or information objects to at least one user.

Also, a system and a method for gathering information descriptions either by automatically collecting information descriptions relevant to a need description or by sending a needs description to users and collecting information descriptions from them are provided according to this invention. The system and the method use an automatic information gathering procedure for collecting information objects based on contents of needs objects from information sources on the network, etc. and also use said notification procedure in order to send needs descriptions to users.

In the needs sharing systems and methods according to this invention, needs objects that are attached to physical entities are described either using formal description languages including query languages and information retrieval languages, using free-form texts in natural languages, or using both formal description languages and natural languages. Also, information objects can contain text, audio, image, video, and hyperlink information.

### DRAWING FIGURES

The preferred embodiments of this invention will be described in detail, with reference to the following figures, wherein:

FIG. 1 is a schematic illustration of an embodiment of an in-store information sharing system according to this invention;

FIG. 2 illustrates an exemplary display of a needs object;

FIG. 3 illustrates an exemplary display of an information object;

FIG. 4 illustrates an exemplary display of a needs object that is described using a formal query language;

FIG. 5 illustrates an exemplary display of a form for notifying a needs object;

FIG. 6 illustrates an exemplary display of a needs object that is notified to a user;

FIG. 7 is a diagram that shows the architecture of a mobile client device used in the in-store information sharing system;

FIG. 8 is a diagram that explains a cooperation method for a shared server and clients in the in-store information sharing system;

FIG. 9 is a schematic illustration of an overall architecture of the in-store information sharing system;

FIG. 10 is a diagram that explains the architecture of a database for managing needs descriptions and information attached to physical entities in the in-store information sharing system;

FIG. 11 is a diagram that shows the structure of data used to realize the in-store information sharing system;

FIG. 12 is a flowchart outlining overall processing steps for attaching a needs object and an information object to a physical entity;

FIG. 13 is a flowchart outlining processing steps for obtaining information of a physical entity;

FIG. 14 is a flowchart outlining processing steps for attaching a needs object to a physical entity;

FIG. 15 is a flowchart outlining processing steps for attaching an information object to a physical entity;

FIG. 16 is a flowchart outlining processing steps for displaying a needs object and an information object that are associated with a physical entity;

FIG. 17 is a flowchart outlining processing steps for notifying a user of a needs object and an information object using a physical entity;

FIG. 18 is a flowchart outlining processing steps for notifying a user of a needs object and an information object without using a physical entity;

FIG. 19 is a flowchart outlining processing steps for displaying a notified needs object and a notified information object;

FIG. 20 is a flowchart outlining processing steps for automatically collecting answers using a needs object;

FIG. 21 is a flowchart outlining processing steps for registering a surrogate object.

REFERENCE NUMBERS IN DRAWINGS

| | |
|---|---|
| 1, 2, 3 | mobile device |
| 34 | mobile database |
| 39, 205 | personal computer |
| 38 | various databases on the network |
| 60, 62, 64, 66 | user |
| 100 | shared server |
| 103 | database |
| 300, 400, 500, 600, 700 | display screen |
| 620, 720 | display window |

### DESCRIPTION

An in-store information sharing system, which is an embodiment of this invention, will be explained using figures. This system allows customers visiting a store to easily create a needs description for obtaining needed information using mobile devices. For the store's staff and information providers, it is possible to serve appropriate information based on clearer understanding of customers' needs and situations. When customer A makes a mobile device recognize a commercial product in a store, the system retrieves needs descriptions (e.g., queries about the commercial product) and other information pieces that are related to said commercial product from a shared server, and displays them on said mobile computing device. Customer A is allowed to not only view the displayed needs descriptions and information but also create needs descriptions and information suited for himself/herself by using the displayed needs descriptions and information.

In General, it is not an easy task to clearly describe one's needs. Therefore, it is desirable that a user is permitted to describe needs immediately at the places where the needs arise using mobile devices, etc. However, even if a means for allowing inputs is provided at the places where the needs arise, there is a problem that some users can only vaguely recognize their needs and that users who are not good at describing needs have difficulty in clearly describing their needs.

Users can share needs objects that are relevant to situations on a shared server. There are cases that users can discover needs objects of their interests by viewing the needs objects registered by other users in the past or that users can easily change other people's needs object to needs objects suited for themselves. Furthermore, sharing of needs objects allows users to draw upon other people's ways of describing needs, and being informed of the contents of other people's needs descriptions allows users to gain various inspirations.

Needs descriptions related to said commercial product and created by customer A are registered on a shared server as needs objects. The registered needs object are shared by users. Using the registered needs objects, the system automatically gathers needed information from various databases and search engines on the network and registers the gathered information on a shared server as information objects. Later, if another customer B is interested in said commercial product in said store, said needs objects are presented on a mobile computing device of customer B. Customer B is allowed to contribute various information in relation to these needs objects. Furthermore, the system can notify said needs objects to specified users if customer A desires. Hereby, queries about a certain commercial product, for example, can be notified to the store's staff. If the store's staff contributes answers for said queries, customer A receives a notification. Furthermore, even when customers are not in the store and do not have said commercial product at hand, the customers can still use various information about said commercial product at anytime by specifying information of said commercial product, which is stored on the customers' mobile devices.

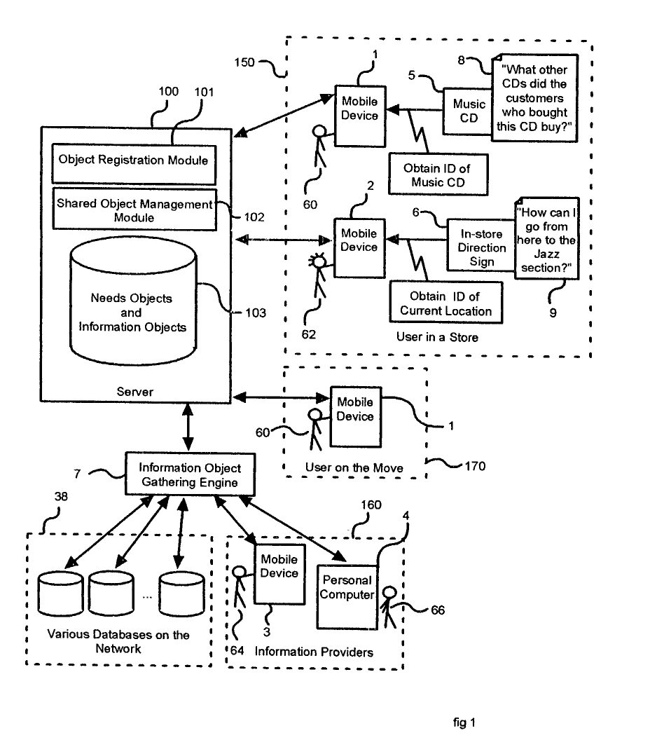

An exemplary use of this in-store information sharing system is illustrated using FIG. 1. The shared server 100 includes a database 103 where needs objects and information objects are stored. Objects in the database 103 are registered and managed by an object registration module 101 and an object management module 102, respectively. Users can share objects stored in the database 103.

When a mobile device 1 in a store 150 obtains the ID of a nearby music CD 5, the device 1 downloads needs objects related to said music CD 5 from the shared server 100 through wireless or wired communication networks. Then, query 8 “What other CDs did the customers who bought this CD buy?” is displayed on the display of the mobile device 1. A method for obtaining IDs will be described later. Note that it is not necessary to perform communications every time between the mobile device 1 and the shared server 100 if objects that are anticipated to be used are downloaded on the device 1 in advance.

Even when a user 60 holding the mobile device 1 is at a location 170 outside the store 150, the user 60 can use needs objects and information objects on the shared server 100.

A user 62 creates a query 9 “How can I go from here to the section for X?” after a mobile device 2 in a store 150 obtains the ID of a nearby in-store direction sign 6. The created query 9 is uploaded to the shared server 100 through wireless or wired networks and registered as a needs object in the database 103. Furthermore, the user 62 can notify the query 9 to other people including the store's staff. Details of a method for notification will be described later.

An information object gathering engine 7 collects information pieces from various databases 38 on the network, a user 64 using a mobile device 3, and a user 66 using a personal computer 4, based on the content of the needs object on the shared server 100, which corresponds to the query 9. If information pieces are collected, a notification message is displayed on the display of the mobile device 2. Details of methods for information gathering and notification will be described later.

In this particular example, the user 62 created the query from scratch. However, it is also possible to create a query by copying and, if necessary, modifying existing information on the shared server 100. For example, if there already exists a query “How can I go from here to the section of Y?” on the shared server 100, the query 9 can be created by replacing the product category name ‘Y’ with the different product category name ‘X’.

Also, needs objects can be described by using database query languages including SQL (Structured Query Language) and other formal query languages as well as natural languages. The information object gathering engine 7 executes needs descriptions in formal query languages on various databases 38 on the network and the information objects obtained as the execution result are stored on the database 103 of the shared server 100 by the information object gathering engine 7. Also, it goes without saying that it is possible to use existing needs descriptions that are registered on the shared server 100 for creating a new needs description even if the needs descriptions are described using formal query languages.

In the above example, the information object gathering engine 7 collected information objects from various databases 38 on the network. However, it goes without saying that it is also possible to collect information objects from search engines on the network. If information objects are collected from search engines on the network, the information object gathering engine 7 generates information retrieval queries based on needs objects and then executes the generated queries on said search engines.

In the above example, the information objects were described using text. However, it is possible to use any kinds of media that mobile devices and personal computers can handle. For example, such media include numbers, sound, image, video, drawing, and Web documents media. If these kinds of media cannot be easily created on mobile devices, personal computers etc. may be used to create media objects with applications for editing different kinds of media and to register the created media object on the shared server 100.

In the above example, the IDs of a music CD and an in-store direction sign were recognized by the system. As further described later, sensors such as barcode scanners and RFID readers can be used. Of course, users can input ID information by using keyboards etc. if IDs are displayed in such a form that humans can recognize. It goes without saying that location information can be used besides ID information. That is, needs objects and information objects can be attached to physical spaces that can be recognized by using location sensors including the ones involving GPS.

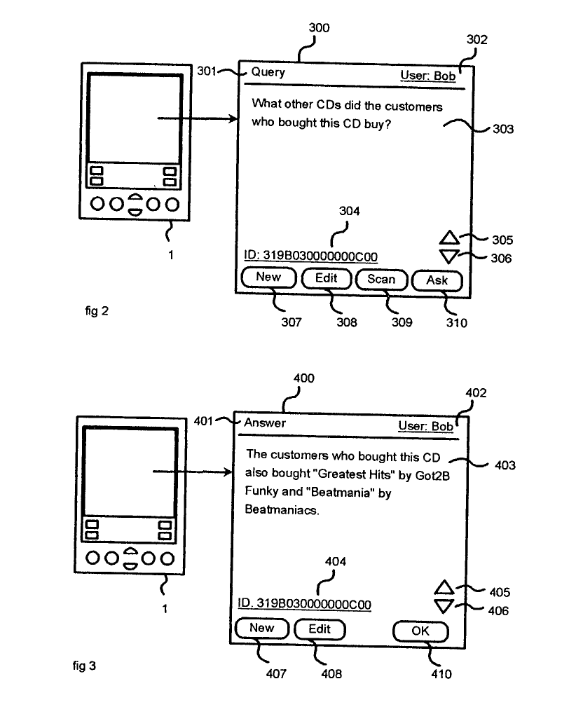

A method for displaying and creating needs objects utilizing the mobile device 1 is explained using FIG. 2. A display screen 300 is a display screen drawn on the display device of the mobile device 1. In order to display a needs object, users only need to place a mobile device sufficiently near a physical entity of interest and press-a scan button 309. An ID sensor reads the ID 304 of the physical entity and then the content 303 of a needs object that is associated with the ID 304 is displayed on the display screen 300 of the mobile device 1. If there are multiple needs objects that are associated with the ID 304, a different needs object in a backward direction or a forward direction can be displayed by pressing scroll buttons 305 or 306, respectively. A label 301 shows that the mobile device 1 currently displays query objects. Query objects are a type of needs objects. A label 302 shows the name of the current user of the system. In this embodiment, RFID readers and barcode scanners are used as ID sensors. It is possible to use other kinds of ID sensors. It is also possible to manually input IDs. Furthermore, it is possible to use location sensors such as the GPS as well as ID sensors. Although, in this embodiment, the system recognizes a physical entity when a user presses the scan button 209, it is possible to display a needs object automatically without requiring the user to press the scan button 209 when the physical entity is located near the mobile device. In order for this to operate, it is sufficient to make the system always communicate with the sensor and continuously monitor the state of environment even if the scan button 209 is not pressed. In order to create a needs object, a user presses a new button 307 or an edit button 308 after the system recognizes a physical entity. Then, the display is switched to an edit window for creating a new needs object. If the user presses the new button 307, the user is presented with an empty edit window where a needs object can be described using input methods such as keyboards and pens. If the user presses the edit button 308, the content 303 of the current needs object is copied and the copy of the needs object is displayed in an edit window where a needs object can be created by modifying the copy of the needs object using input methods such as keyboards and pens. Note that methods for displaying and creating needs objects are not limited to the ones that are described above. Also, the same methods as the ones that are used on the mobile device 1 can be used on the mobile device 2 and 3.

Next, methods for displaying and creating information objects using the mobile device 1 are explained using FIG. 2 and FIG. 3. A display screen 400 is drawn on the display device of the mobile device 1. In order to display information objects, it is sufficient to press an ask button 310 in FIG. 2 when a needs object is displayed. Information objects related to said need object are retrieved from the content of the database 103 and the content 403 of the retrieved information objects is displayed on the display screen 400 of the mobile device 1. If multiple information objects are related to said needs object, a user can use the scroll buttons 405 and 406 to display contents of next and previous information objects. A label 401 indicates that the current display screen is a display screen for answer objects. Answer objects are a specialized form of information objects. A label 402 indicates the name of the current user. In order to create an information object, a user presses a new button 407 or an edit button 408. Then, the display is switched to an edit window for creating a new information object. If the user presses the new button 407, the user is presented with an empty edit window where an information object can be described using input methods such as keyboards and pens. If the user presses the edit button 408, the content 403 of the current information object is copied and the copy of the information object is displayed in an edit window where an information object can be created by modifying the copy of the information object using input methods such as keyboards and pens. In this embodiment, a method for displaying information objects that are associated with needs objects was explained. Since needs objects are associated with physical entities, information objects are indirectly associated with said physical entities. It is also possible to directly associate information objects with physical entities. Data structures for this will be described later. It is possible to display and create an information object using the method of FIG. 3 even if the information object is directly associated with a physical entity. Note that methods for displaying and creating information objects are not limited to the ones that are described above. Also, the same methods as the ones used on the mobile device 1 can be used on the mobile device 2 and 3.

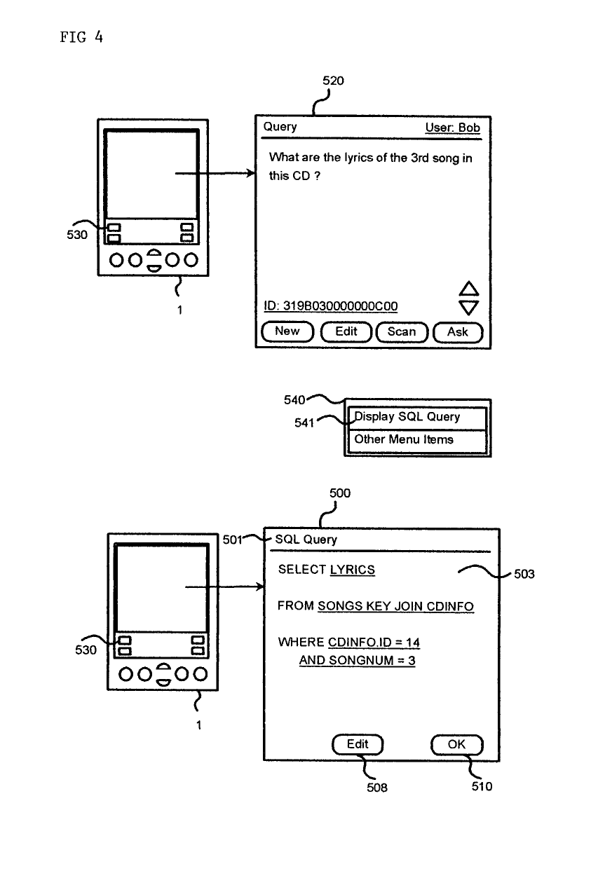

Next, methods for displaying and creating formal needs descriptions using a database query language, specifically, the structured query language (SQL) are explained using FIG. 4. Display screens 500 and 520 are drawn on the display device of the mobile device 1. A label 501 of the display screen 500 indicates that the current display screen is for SQL query objects. SQL query objects are a specialized form of needs objects. The content 503 of an SQL query object displayed in the display screen 500 corresponds to the content of a query object “What are the lyrics of the 3^{rd} song in this CD?” displayed in the display screen 520. Underlined areas in the content 503 of the query object indicates information that users are allowed to edit. If the user presses a menu button 530 while the display screen 520 is displayed, a menu 540 is presented. If the user selects a menu item 541 “Display SQL Query”, the display screen 500 is then displayed. Pressing an OK button 510 in the display screen 500 brings up the display screen 520 again. Methods for displaying and creating needs objects that are displayed on the display screen 520 are the same as the methods for displaying and creating needs objects, which are described above. SQL query objects are created automatically, i.e., when a needs object is created, an empty SQL query object is automatically generated and associated with said needs object. When a needs object is copied, an associated SQL query object is also copied. If the user presses an edit button 508 in the display screen 500, an edit window for SQL queries is displayed, where the user can modify the content 503 of the SQL query object. That is, each user can draw upon a shared SQL query object and modify the shared SQL query object into an own SQL query object. With this embodiment, methods for displaying and creating a needs object in a formal language that is associated with a needs object in a natural language are described. The association between needs objects in a formal language and ones in a natural language are characterized by one-to-one relationships. These two types of needs objects play complementary roles here. However, it is not mandatory to associate needs objects in a formal query language with needs objects in a natural language. Needs objects in a formal query language can be directly attached to physical entities. Note that methods for displaying and creating needs objects using a formal language are not limited to the ones that are described above. Also, the same methods as the ones used on the mobile device 1 can be used on the mobile device 2 and 3.

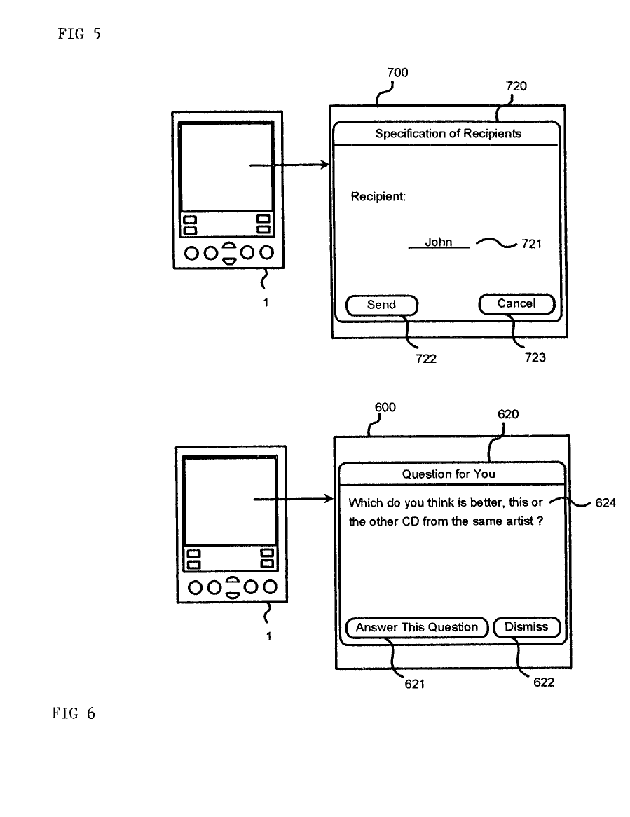

Next, a method for sending specified needs objects is explained using FIG. 5. To specify a needs object and send it, the user specifies a recipient using a display window 720. If the user specifies the name of the recipient in an input field 721 and presses a send button 722, said needs object is sent to the specified user. If the user presses a cancel button 723 instead of the send button 722, the process for sending a needs object is aborted. The sent needs object is registered in the database 103 and delivered to the recipient user by either presenting the needs object on the mobile device of the recipient user or sending an email message. In this embodiment, the user inputs a user name or a user group name that is defined in advance in the input field 721. It goes without saying that users can input multiple user names and user group names at the same time. Note that the method for sending needs objects is not limited to the ones that are described above.

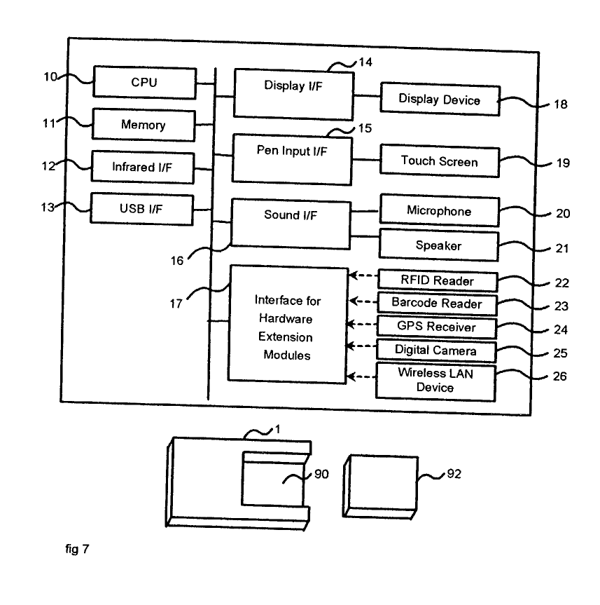

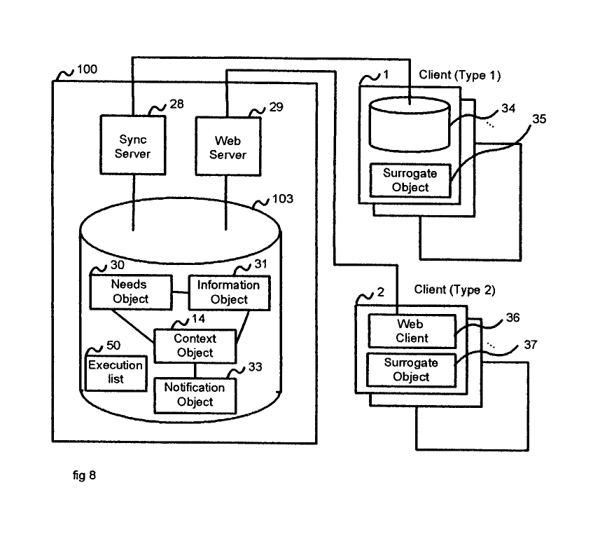

Next, a method for displaying received needs objects is explained using FIG. 6. A display window 620 is displayed on the mobile device of the user who received the needs object that was sent according to the method described above. The content 624 of the sent needs object is displayed in the display window 620. If the user presses an “answer this question” button at this point, the user is able to create a new information object using an edit window for information objects and then add the information object to the database 103. If the user presses a ‘dismiss’ button instead of “answer this question” button, the display screen 600 reverts to the state before the display window 620 was displayed. Note that the method for displaying received needs objects is not limited to the ones that are described above.

FIG. 7 shows the architecture of the mobile device 1. The architecture of the mobile devices 2 and 3 are the same as the device 1. Similar to regular computers, this mobile device has a CPU (central processing unit) 10, a memory 11, and a display device 18. Text and image information generated by the CPU 10 is drawn on the display device 18 via a display interface 14. The display device 18 is combined with a touch screen 19 that reports to the CPU 10 when the user touches on the touch screen 19 with a pen or a finger. The user inputs characters and drawings on the mobile device using a pen or a finger.

This mobile device has a microphone 20 for recording sound and a speaker 21 for generating sound. The analog sound signals input by the microphone 20 is converted by a sound processing device 16 to digital signals that can be processed-by the CPU 10. Furthermore, according to instructions by the CPU 10, digital signals are converted by the sound processing device 16 to analog sound signals which are generated from the speaker 21.

This mobile device is equipped with a slot 90 where various kinds of hardware extension modules 92 can be attached to and detached from. The CPU 10 communicates with an attached hardware extension module via a hardware extension interface 17.

An RFID reader device 22 is a type of hardware extension modules 92 that reads out information in RFID tags located within a certain distance from this mobile device. RFID tags consist of microchips connected to small antennas where information can be stored in the microchips. The information stored in an RFID tag is sent out to the RFID reader device 22 according to a request from the RFID reader device 22. RFID tags and the RFID reader 22 communicate wirelessly using antennas. Suppose RFID tags are attached to or embedded in physical entities such as commercial products in a store. The mobile device reads out identification information of the RFID tag that is embedded in a nearby physical entity via the RFID reader device 22 and thus identifies said physical entity.

A barcode scanner device 23 is a type of hardware extension modules 92 that reads out information printed on a barcode located within a certain distance from this mobile device. The barcode reader 23 reads barcode information that is printed on physical entities such as commercial products in a store and the physical entities are identified. Note that if existing barcodes that are printed on commercial products etc. are used, two different physical entities of the same product name are not distinguished. If it is necessary to distinguish these physical entities, it may be useful to supplement the barcode information with information provided by other ID sensors including RFID readers, location sensors such as the GPS.

The GPS is a type of hardware extension modules 92 that simultaneously receives signals from multiple GPS satellites and computes information about the current position. The mobile device uses the computed information about the current position to recognize that said mobile device exists within a specific physical area. Physical areas as well as physical objects are a specialized form of physical entities. It is possible to attach needs objects and information objects to physical areas and share the objects.

A digital camera device 25 is a type of hardware extension module 92 that provides freedom to take a picture of the areas around the mobile device. The photographed static images are stored in a memory 11 as digital information that can be processed by the CPU 10. It is possible to read identification information represented by a two dimensional barcode attached on a physical entity such as a commercial product and identify the physical entity by taking a picture of the two dimensional barcode, storing the taken picture on the memory 11, and processing the picture by the CPU 10.

A wireless LAN device 26 is a type of hardware extension module 92 that allows for communication of information with other computers and mobile devices via a nearby base station. Identifying the station that the wireless LAN device 26 is using recognizes the fact that the mobile device exists within a specific physical area. It is possible to attach needs objects and information objects to the recognized physical area and share the objects.

An infrared interface 12 allows for communication of information with other computers and mobile devices. The mobile device can communicate information with other nearby mobile devices via the infrared interface 12. In addition, the mobile device can communicate information with other computers and remote mobile devices via an infrared communication station.

USB (Universal Serial Bus) communication device 13 allows for communications with computers via connection cables. Connecting the mobile device and a computer using a USB connection cable allows for communications between the mobile device and the computer.

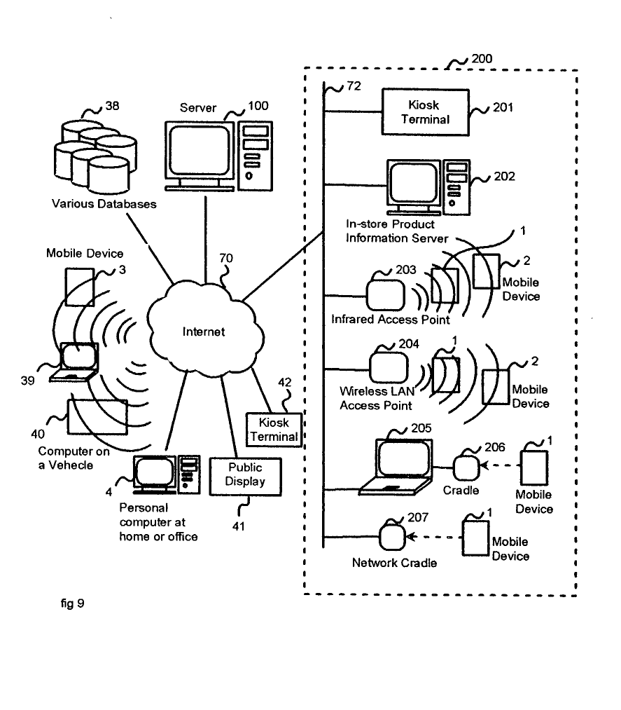

FIG. 8 shows the relationship between the shared server 200 and clients in the in-store information sharing system. The database 103 of the shared server 100 contains needs objects 30, information objects 31, and context objects 32 that include information about physical entities. Solid lines connect related objects. Related objects are associated with each other by the reference structure in the database system. Notification objects 33 are objects for notifying users of needs descriptions and information. An execution list 50 is used to automatically collect information objects using needs objects. Detailed structure and use methods of these objects will be described later. Clients of the shared server 100 are mobile devices running a software program that can communicate with the shared server.

Clients can be classified into type one and type two clients according to the architecture of the software program running on the clients. Multitude of type one and type two clients communicate with the shared server 100 at the same time or at different times, and thereby share and use the needs objects 30, the information objects 31, the context objects 32, the notification objects 33, the execution list 50 stored on the database 103.

The mobile device 1 is a type one client. The mobile device 1 has a mobile database 34 that synchronizes with the database 103 in a bi-directional fashion. A synchronization server 28 makes the database 103 reflect the information that is updated on the mobile database 34 according to pre-specified conditions. Also, the synchronization server 28 make the mobile database 34 reflect the information that is updated on the database 103 according to pre-specified conditions. Even when the mobile device 1 and the shared server 100 are temporarily unable to communicate with each other, the user of the device 1 is allowed to continuously utilize the system by using the mobile database 34. When the communication becomes possible, the database 103 reflects the updated information on the mobile database 34. Surrogate objects 35 allow the user to reference needs descriptions and information of a physical entity even when the physical entity does not exist near the user. The surrogate objects 35 reference the context objects 32. Details of the structure of the surrogate objects will be described later. Surrogate objects are always available on the mobile device once they are created. Type one clients are suitable for devices with relatively large memory capacity such as notebook computers, handheld devices, and PDA (Personal Digital Assistants).

The mobile device 2 is a type two client. A Web client 36 on the mobile device 2 uses the database 103 via a Web server 29 by using the hyper text transfer protocol (HTTP). The mobile device stores surrogate objects in the same way as type one clients do. Since a type two client does not have a mobile database on a mobile device, it is easy to realize a type two client on a device with extremely limited memory capacity. However, the user of the mobile device 2 is temporarily unable to use the system when the mobile device 2 and the shared server 100 are temporarily unable to communicate with each other. Type two clients are suitable for devices with small memory capacity such as mobile phones or devices that can be always connected to the network using fast wired communications such as kiosk terminals.

The overall architecture of this in-store information sharing system is explained using FIG. 9. A kiosk terminal 201 and a store information server are installed in a store and are connected via a wired LAN 72. Mobile devices 1 and 2 in the store are connected to the network using various methods. One of the methods is to connect via an infrared access point 203. It is possible to directly use the network via the infrared device 12 embedded in the mobile device without establishing wired connections. Another method is to connect via a wireless LAN access point 204. Furthermore, another method is to connect via a cradle 206 that is connected to a personal computer 205. The personal computer 205 is connected to the network. A cradle has a physical property that can hold a mobile device placed on a table vertically. A mobile device held by a cradle can communicate outside via the electronic circuit in the cradle. Also, another method is to connect via a network cradle 207. The network cradle 207 is capable of directly connecting to the network without requiring a personal computer. A wired LAN 72 is connected to the Internet 70. The shared server 100, various databases 38, a mobile device 3, a personal computer 39, a computer 40 on a vehicle, a personal computer 4 at home or office, a display device on the street 41, and a kiosk terminal 42 can all communicate with various devices in the store 200 via the Internet 70.

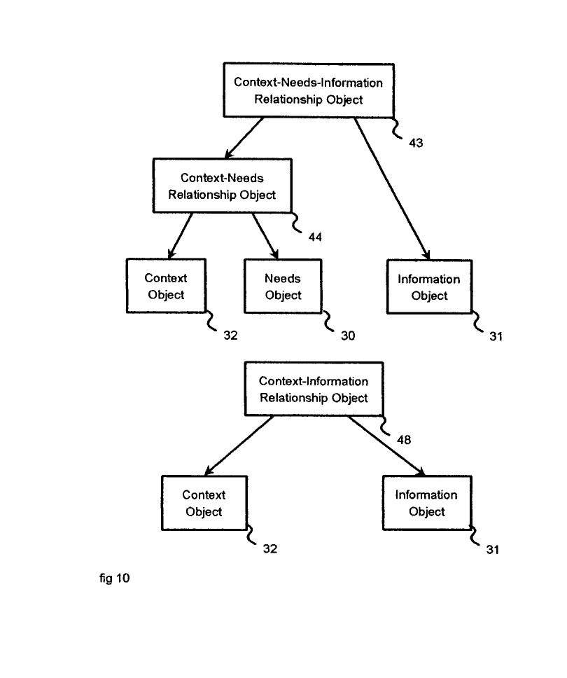

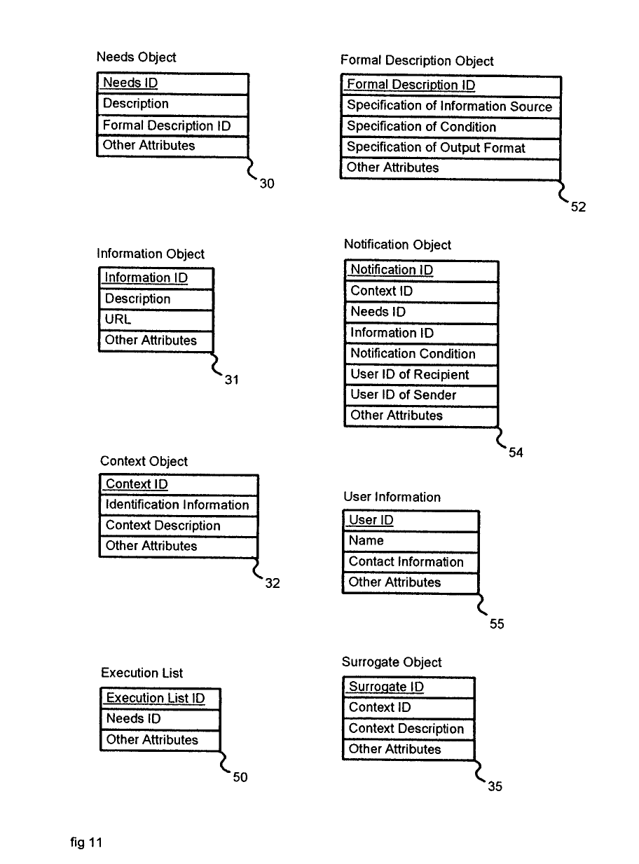

Relationships of various objects that are managed on the database 103 of the shared server 100 are explained using FIG. 10. This in-store information sharing system realizes the data structure shown in FIG. 10 by using a relational database system. However, it is possible to realize the data structure in FIG. 10 by using other types of database systems including object-oriented database systems and network database systems or by using a file system. The relationship between needs objects and context objects 32 that contain information about physical entities is a many-to-many relationship. Context-needs relationship objects 44, which are a data structure for managing said many-to-many relationship, reference the context objects 32. Note that the relationship between the context-needs relationship objects 44 and the context objects 32 is a many-to-one relationship. Similarly, the context-needs relationship objects reference the needs objects 30. Note that the relationship between the context-needs relationship objects 44 and the needs objects 30 is a many-to-one relationship. It is possible to attach the same needs object to different physical entities using said many-to-many relationship. For example, if a needs object that describes a query “What is this?” is attached to various physical entities, the meaning of each is different. Furthermore, said many-to-many relationship makes it possible to attach multiple needs objects 30 to the same physical entity.

The relationship between the context-needs relationship objects 44 and information objects 31 is a many-to-many relationship. Context-needs-information relationship objects 43, which are a data structure for managing said many-to-many relationship, reference the context-needs objects 44. Note that the relationship between the context-needs-information relationship objects 43 and the context-needs relationship objects 44 is a many-to-one relationship. Similarly, the context-needs-information relationship objects 43 reference the information objects 31. Note that the relationship between the context-needs-information relationship objects 43 and the information objects 31 is a many-to-one relationship. It is possible to attach the same information object 31 to different context-needs relationship objects 44 using said many-to-many relationship. For example, an information object that contains a guide map of a store can be associated with various queries (needs objects) about locations of selling spaces. Furthermore, multiple information objects 31 can be attached to the same context-needs relationship object 44.

The context objects 32 and the information objects 31 are either associated via the context-needs relationship objects 44 and the context-needs-information relationship objects 43 or associated directly via context-information relationship objects 48 without the needs objects 30. In the latter case, a many-to-many relationship between the context objects 32 and the information objects 31 is realized by the references from the context-information relationship objects 48 to the context objects 32 and to information objects 31. Note that it is possible to attach the same information object 31 to different context objects 32 and to attach multiple information objects 31 to the same context object 32.

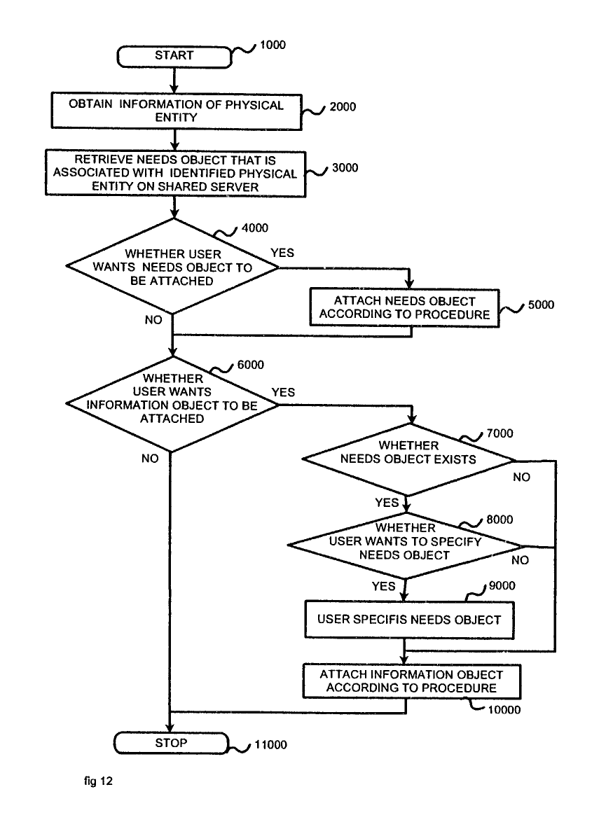

A data structure that is used to realize this in-store information sharing system is explained using FIG. 11. The needs ID of a needs object 30 that describes a need of a user is an identifier for uniquely identifying a needs object. The description text is a text where the content of the needs is described in a free form. The formal description ID references a formal description object 52 that describes said needs object in a formal language.

The information ID of an information object 31, which is associated with needs objects and context objects, is an identifier for uniquely identifying an information object. The description text is a text where the content of the information is described in a free form. The URL is a URL (Universal Resource Locator) of a Web site that is related to said information.

A context object 32 containing information about a physical entity determines what the needs descriptions and the information provided by needs objects and information objects are about. The context ID is an identifier for uniquely identifying a context object. The identification information of a physical entity is any information for identifying a physical entity. For example, a barcode number, an identification number of an RFID tag, location information obtained from the GPS are stored here.

An execution list 50 is used for automatically collecting relevant information objects from various information sources on the network based on needs objects. The execution list ID is an identifier that uniquely identifies an execution list item. The needs ID references a needs object that is used for collecting information objects. If the formal description of the referenced needs object is, for example, a query in the database query language SQL (Structured Query Language), the system executes this query and add the resulting information objects 31 to the database 103. Details of a processing procedure using an execution list will be described later.

A formal description object 52, which is referenced by needs objects 30, is a need described in a formal language such as database query languages, XML (Extensible Markup Language) queries, and information retrieval queries. Processing the content of the formal description object 52 with a computer generates some information as a result. The formal description ID is an identifier for uniquely identifying a formal description object. The specification of information source specifies an information source if the information source provides information that satisfies the needs described by the formal description object 52. The specification of a condition is a definition that formally specifies a need using logical expressions, etc. The specification of an output format specifies how users want the needed information to be displayed on a display device. Also, if multiple information objects are output, their display order is specified by using the specification of an output format.

A notification object 54 is used to send specified users a needs object or an information object that is attached to a certain context object. The sent information is either displayed on a user's mobile device or delivered to said user by email. The notification ID is an identifier for uniquely identifying a notification object. The context ID references a context object to notify. The needs ID references a needs object to notify. The information ID references an information object to notify. The notification condition specifies the timing for a notification using a time range, the number of times the user visited a physical entity, etc. The user ID of a recipient references the user information of the user who should receive a notification. The user ID of a sender references the user information of the user who sent a notification.

User information 55 is used to store and retrieve information related to the users of the system. The user ID is an identifier for uniquely identifying user information. The name is the name of a user and the contact information includes email addresses, phone numbers and addresses. The email addresses of the contact information can be used for delivering the content of the notification object 54 by email.

A surrogate object 35 is an object for allowing the user to reference needs descriptions and information of a physical entity even when the physical entity does not exist near the user. The surrogate ID is an identifier for uniquely identifying a surrogate object. The context ID references the context object 32 that is a source of the surrogate object. The context explanation is a short text for explaining the referenced context object 32 to the user. This can be different from the context description in the context object 32. For example, a bookmark list of physical entities that were used in the past is prepared on the mobile device and the user displays the bookmark list. Each item of the list corresponds to a surrogate object and specifying an item calls out a context object corresponding to a surrogate object. Then, relevant needs descriptions and information descriptions can be displayed on the mobile device.

Note that in the data structure of FIG. 11, the surrogate object 51 is at least stored on the mobile device. Other objects are at least stored on the database 103.

An example of a procedure for attaching needs objects and information objects to physical entities according to this invention is explained using FIG. 12. Processing begins in step 1000 and continues to step 2000. In step 2000, information about a physical entity including barcode numbers and identification numbers of RFID tags is obtained according to the corresponding procedure. Next, in step 3000, needs objects that are associated with the recognized physical entity are retrieved on the shared server 100 and processing continues to step 4000. In step 4000, a determination is made as to whether to attach a needs object. If attaching a needs object is desired, processing continues to step 5000. Otherwise, processing jumps to step 6000. In step 5000, a needs object is attached according to the corresponding procedure. Then, processing continues to step 6000. In step 6000, a determination is made as to whether to attach an information object. If attaching an information object is desired, processing continues to step 7000. Otherwise, processing jumps to step 11000, where the processing sequence ends. In step 7000, a determination is made as to whether a needs object exists for said physical entity. If there is a needs object, processing continues to step 8000. Otherwise, processing jumps to step 10000. To associate the information object with an existing needs object, the needs object should first be specified. For this reason, in step 8000, a determination is made as to whether to specify a needs object. If specifying a needs object is desired, processing continues to step 9000. Otherwise, processing jumps to step 10000. In step 9000, the user selects a needs object and processing continues to step 10000. In step 10000, an information object is attached according to the corresponding procedure and processing continues to step 11000 where the processing sequence ends.

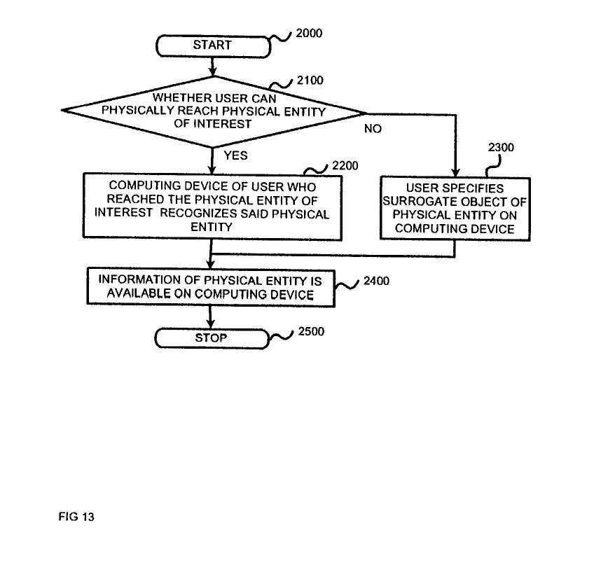

An example of a procedure for obtaining information about a physical entity according to this invention is explained using FIG. 13. Processing begins in step 2000 and continues to step 2100. In step 2100, a determination is made as to whether it is possible to reach a physical object of interest. If reaching is possible, processing continues to step 2200. Otherwise, processing continues to step 2300. In step 2200, a computing device of the user who reached a physical entity of interest recognizes said physical entity and processing continues to step 2400. Methods of recognition include manual inputs by users as wells as automatic methods using various sensors shown in FIG. 7. In step 2300, the user specifies a surrogate object of a physical entity on a computing device and processing continues to step 2400. In step 2400, information about a physical entity is available for use on a computing device and processing continues to step 2500 where the processing sequence ends.

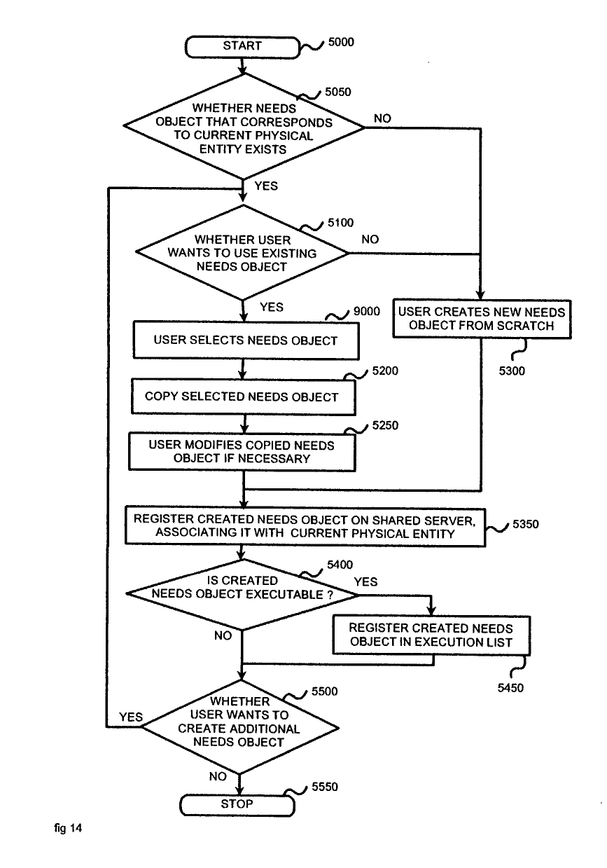

Next, an example of a procedure for attaching a needs object to a physical entity according to this invention is explained using FIG. 14. Processing begins in step 5000 and continues to step 5050. In step 5050, a determination is made as to whether there exists a needs object that corresponds to the current physical entity. If there exists such a needs object, processing continues to step 5100. Otherwise, processing jumps to step 5300. In step 5100, a determination is made as to whether to use an existing needs object for creating a new object. If using an existing needs object is desired, processing continues to step 9000. Otherwise, processing continues to step 5300. In step 9000, the user selects an existing needs object for creating a new needs object and processing continues to step 5200. In step 5300, the user creates a needs object from scratch and processing jumps to step 5350. In step 5200, the needs object selected in step 9000 is copied and processing continues to step 5250. In step 5250, the user makes necessary changes on the copied needs object and processing continues to step 5350. In step 5350, the created needs object is associated with the current physical entity and registered on the shared server 100 and processing continues to step 5400. In step 5400, a determination is made as to whether the created needs object is executable. If it is executable, processing continues to step 5450. Otherwise, processing jumps to step 5500. In step 5450, the created needs object is registered in a execution list and processing continues to step 5500. In step 5500, a determination is made as to whether to create additional needs objects. If creating additional objects is desired, processing returns to step 5100. Otherwise, processing continues to 5550 where the processing sequence ends.

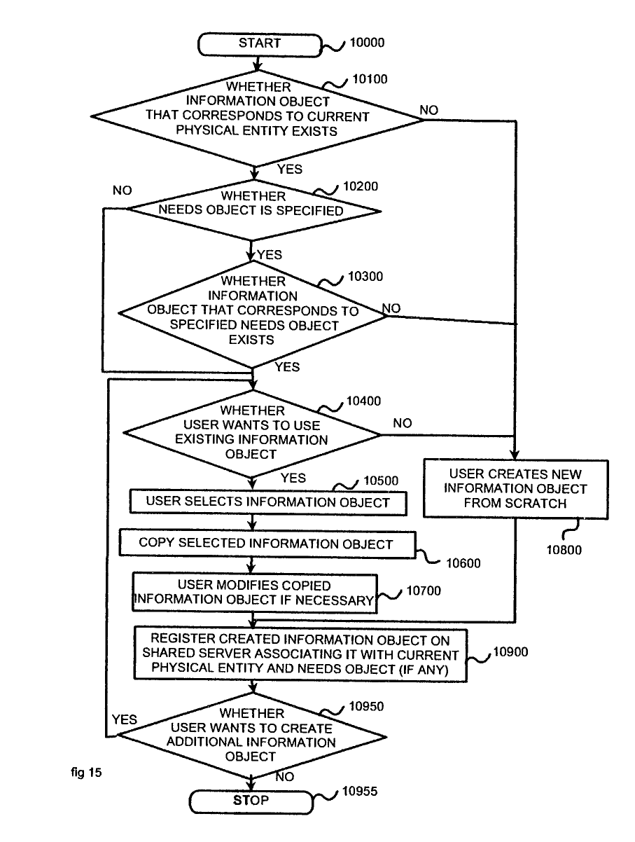

Next, an example of a procedure for attaching an information object to a physical entity according to this invention is explained using FIG. 15. Processing begins in step 10000 and continues to step 10100. In step 10100, a determination is made as to whether there exists an information object that corresponds to the current physical object or physical entity. If there exists such an information object, processing continues to step 10200. Otherwise, processing jumps to step 10800. In step 10200, a determination is made as to whether a needs object is already specified. If it is already specified, processing continues to step 10300. Otherwise, processing jumps to step 10400. In step 10300, a determination is made as to whether there exists an information object that corresponds to a specified needs object. If there exists such an information object, processing continues to step 10400. Otherwise, processing jumps to 10800. In step 10400, a determination is made as to whether to use an existing information object for creating a new object. If using an existing information object is desired, processing continues to step 10500. Otherwise, processing jumps to step 10800. In step 10500, the user selects an existing information object for creating a new information object and processing continues to step 10600. In step 10800, the user creates an information object from scratch and processing jumps to step 10900. In step 10600, the selected information object is copied and processing continues to step 10700. In step 10700, the user makes necessary changes on the copied information object and processing continues to step 10900. In step 10900, the created information object is associated with the current physical entity and needs object (if specified) and registered on the shared server 100 and processing continues to 10950. In step 10950, a determination is made as to whether to create additional information objects. If creating additional information objects is desired, processing returns to 10400. Otherwise, processing continues to 10955 where the processing sequence ends.

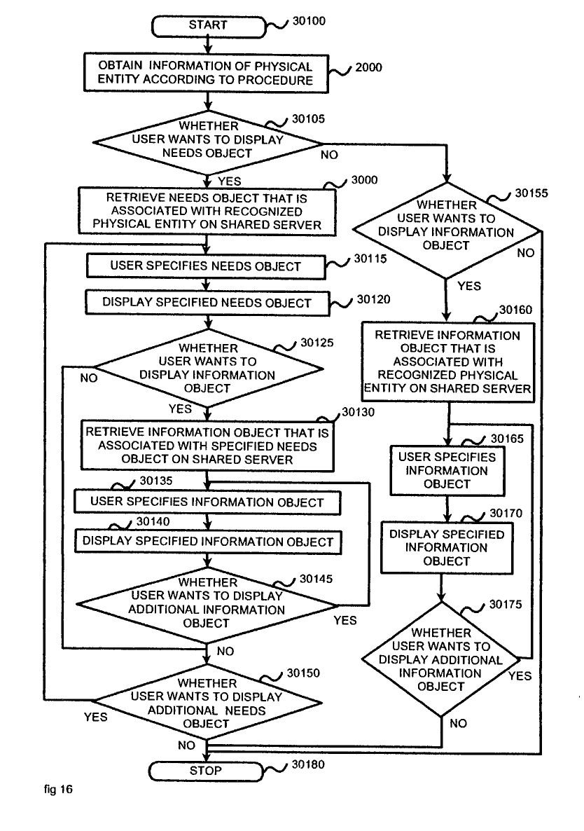

Next, an example of a procedure for displaying a needs object and an information object attached to a physical entity according to this invention is explained using FIG. 16. Processing begins in step 30100 and continues to step 2000. In step 2000, information about an physical entity including barcode numbers and identification numbers of RFID tags is obtained according to the corresponding procedure and processing continues to step 30105. In step 30105, a determination is made as to whether to display a needs object. If displaying a needs object is desired, processing continues to step 3000. Otherwise, processing continues to step 30155. In step 3000, needs objects that are associated with the recognized physical entity are retrieved on the shared server 100 and processing continues to step 30115. In step 30115, the user specifies a needs object to display and processing continues to step 30120. Instep 120, the specified needs object is displayed and processing continues to step 30125. In step 30125, a determination is made as to whether display an information object. If displaying an information object is desired, processing continues to step 30130. Otherwise, processing jumps to 30150. In step 30130, information objects that are associated with the specified needs object are retrieved on the shared server and processing continues to step 30135. In step 30135, the user specifies an information object to display and processing continues to step 30140. In step 30140, the specified information object is displayed and processing continues to 30145. In step 30145, a determination is made as to whether to display additional information objects. If displaying additional objects is desired, processing returns to step 30135. Otherwise, processing continues to step 30150. In step 30150, a determination is made as to whether to display additional needs objects. If displaying additional objects is desired, processing returns to step 30115. Otherwise, processing continues to step 30180 where the processing sequence ends. In step 30155, a determination is made as to whether to display an information object. If displaying an information object is desired, processing continues to step 30160. Otherwise, processing jumps to step 30180 where the processing sequence ends. In step 30160, information objects that are associated with the recognized physical entity are retrieved on the shared server and the processing continues to step 30165. In step 30165, the user specifies an information object to display and processing continues to step 30170. In step 30170, the specified information object is displayed and processing continues to step 30175. Instep 30175, a determination is made as to whether to display additional information objects. If displaying additional objects is desired, processing returns to step 30165. Otherwise, processing continues to step 30180 where the processing sequence ends.

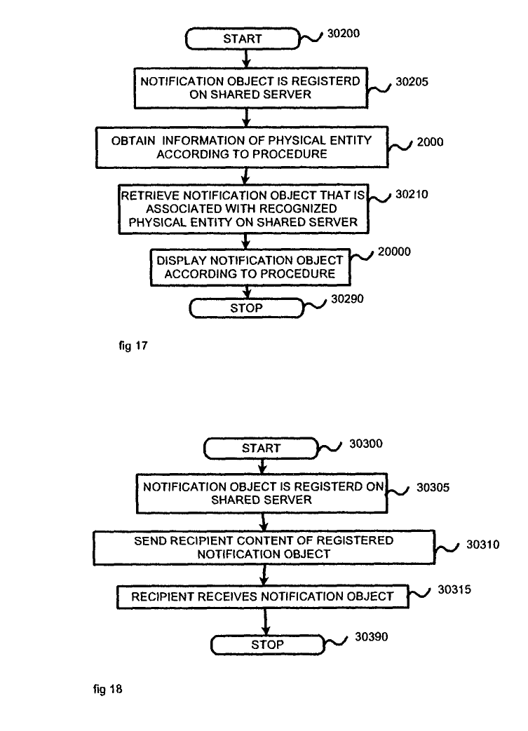

Next, an example of a procedure for notifying a user of a needs object and an information object using a physical entity according to this invention is explained using FIG. 17. Processing begins in step 30200 and continues to step 30205. In step 30205, a notification object is registered on the shared server by a sender that is either a user or a computer program and processing continues to step 2000. In step 2000, a recipient obtains information of a physical entity according to the corresponding procedure and processing continues to step 30210. In step 30210, notification objects that are associated with the recognized physical entity are retrieved on the shared server and processing continues to step 20000. In step 20000, notification objects are displayed on the computing device of the recipient according to the corresponding procedure and processing continues to step 30290 where the processing sequence ends.

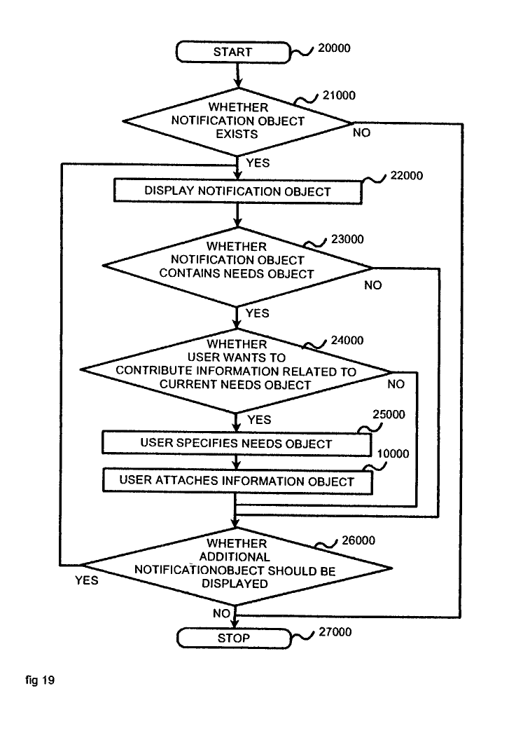

Next, an example of a procedure for notifying a user of a needs object and an information object without using a physical entity according to this invention is explained using FIG. 18. Processing begins in step 30300 and continues to step 30305. In step 30305, a notification object is registered on the shared server by a sender that is either a user or a computer program and processing continues to step 30310. In step 30310, the content of the registered notification object is sent by using methods such as email and processing continues to step 30315. In step 30315, a recipient receives the content of the notification object and displays it using an application program such as an email application that can display the content of the notification object and processing continues to step 30390 where the processing sequence ends.

Next, an example of a procedure for displaying notified needs objects and information objects on the computing device of a recipient according to this invention is explained using FIG. 19. Processing begins in step 20000 and continues to step 21000. In step 21000, a determination is made as to whether there exists a notification object that is associated with the current physical entity. If there exists such a notification object, processing continues to step 22000. Otherwise, processing continues to step 27000 where the processing sequence ends. In step 22000, a notification object is displayed on a computing device of the recipient user and processing continues to step 23000. In step 23000, a determination is made as to whether said notification object contains a needs object. If it does, processing continues to step 24000. Otherwise, processing jumps to step 26000. In step 24000, a determination is made as to whether the recipient user wants to contribute information related to the current needs object. If the user wants to contribute information, processing continues to step 25000. Otherwise, processing jumps to step 26000. In step 25000, the recipient specifies a needs object and processing continues to step 10000. In step 10000 the user attaches information objects and processing continues to step 26000. In step 26000, a determination is made as to whether to display additional notification objects. If displaying additional notification objects is desirable, processing returns to step 22000. Otherwise, processing continues to step 27000 where the processing sequence ends.

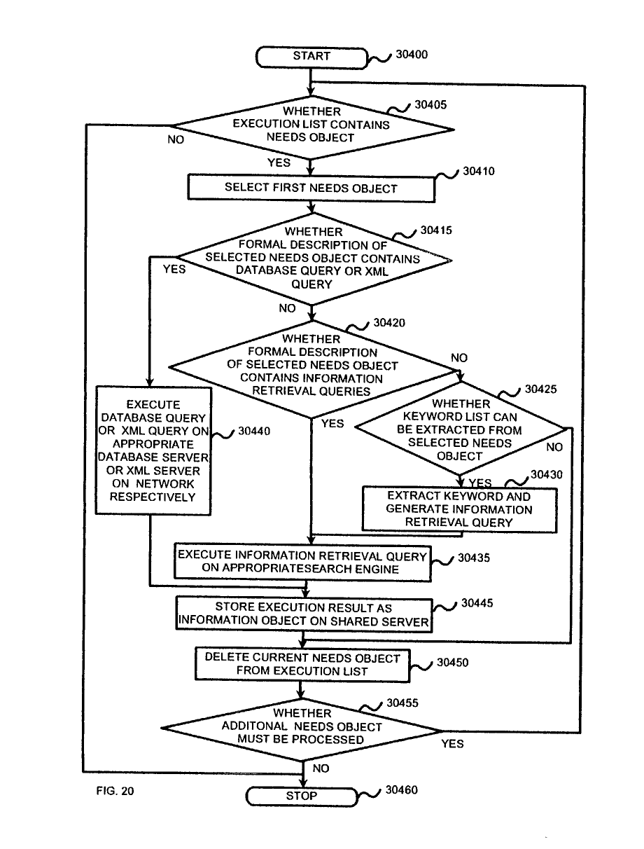

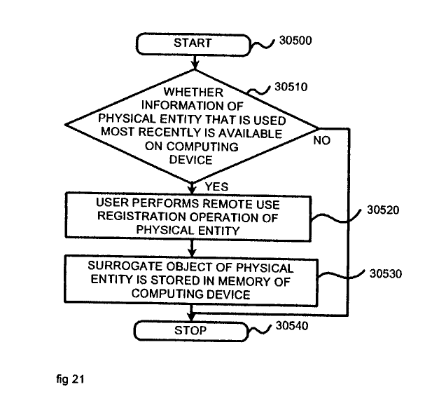

Next, an example of a procedure for automatically collecting answers using needs objects according to this invention is explained using FIG. 20. Processing begins in step 30400 and continues to step 30405. In step 30405, a determination is made as to whether a needs object is registered in the execution list 50. If a needs object is registered, processing continues to step 30410. Otherwise, processing jumps to step 30460 where the processing sequence ends. In step 30410, the first needs object in the execution list 50 is selected and processing continues to step 30415. In step 30415, a determination is made as to whether an executable database query or XML (Extensible Markup Language) query is registered as the formal description of the selected needs object. If such a query is registered, processing continues to step 30440. Otherwise, processing continues to step 30420. In step 30440, said database query or said XML (Extensible Markup Language) query is executed on an appropriate database server or XML (Extensible Markup Language) server on the network and processing continues to step 30445. In step 30420, a determination is made as to whether the selected needs object contains an executable information retrieval query. If the selected needs object contains an executable information retrieval query, processing jumps to step 30435. Otherwise, processing continues to step 30425. In step 30425, a determination is made as to whether a keyword list can be extracted from the selected needs object. If a keyword list can be extracted, processing continues to 30430. Otherwise, processing jumps to 30450. In step 30430, an information retrieval query is generated by using keywords that are extracted from the description text of the needs object etc. and processing continues to step 30435. In step 30435, the information retrieval query is executed on an appropriate search engine and processing continues to step 30445. In step 30445, the result of the execution is registered on the shared server as information objects and processing continues to step 30450. In step 30450, the current needs object is deleted from the execution list and processing continues to step 30455. In step 30455, a determination is made as to whether to continue processing. If continuing processing is desirable, processing returns to step 30405. Otherwise, processing continues to step 30460 where the processing sequence ends.

Next, an example of a procedure for registering a surrogate object according to this invention is explained using FIG. 21. Processing begins in step 30500 and continues to step 30510. In step 30510, a determination is made as to whether information of a physical entity that was most recently used on a computing device is available. If the information is available, processing continues to step 30520. Otherwise, processing jumps to step 30540 where the processing sequence ends. In step 30520, the user performs a registration operation for remote uses of the physical entity and processing continues to step 30530. That is, a surrogate object is created on said computing device and the created surrogate object references a context object that has the information of said physical entity. In step 30530, the surrogate object is stored in a memory space of the computing device and processing continues to step 30540 where the processing sequence ends.

The systems and the methods according to this invention have been implemented using a program running under Palm OS® and a relational database management system. The former realizes the type one client illustrated in FIG. 8. The latter realizes the database 103, the synchronization server 208, and the mobile database 34. The realized type one client uses a PDA (Persona Digital Assistant) and allows for freely attaching and detaching the RFID tag reader device 22 and barcode scanner device 23. The realized type one client can automatically obtain identifiers of physical entities. The realized system utilizes objects other than the surrogate objects 35 in FIG. 11. The system realizes all steps except for 7000 and 8000 in FIG. 12, all steps except for 2300 in FIG. 13, all steps in FIG. 14, all steps in FIG. 15, all steps except for 30155-30175 in FIG. 16, all steps in FIG. 17, all steps in FIG. 18, all steps in FIG. 19, all steps except for 30420-30435 in FIG. 20.

Therefore, it is apparent that there has been provided in accordance with the present invention methods and an apparatus for allowing multiple users to share needs and information using physical entities. While this invention has been described in conjunction with preferred embodiments thereof, it is evident that many alternatives be apparent to those with regular knowledge in the art.

### EFFECT OF INVENTION

The systems and the methods according to this invention allows each user to specify and obtain needed information using physical entities more easily than existing systems, which do not allow for sharing of needs descriptions. For example, in a store, a mobile device automatically recognizes a commercial product at hand and displays various people's queries related to said commercial product. Users, even if they may be unfamiliar with the use of the system, can reuse or consult these queries, create own queries, and easily collect information.

Furthermore, the system makes it easier for information providers to serve information that meets the needs of each user. For example, it is possible to serve information which is as close to the information said user needs as possible based on various customers' needs descriptions attached to said commercial product.

Also, the systems and the methods according to this invention are based on the speculation that users can describe needs related to a physical entity more easily and concretely when the users have the physical entity at hand than when the users only take a look at a photograph or a description text of said physical entity, which is displayed on a computer screen. For example, customers who are about to buy a radio cassette player can specify queries about the radio cassette player more easily and concretely when the customers

What is claimed is:

1. A system for sharing information needs that recognizes at least one physical entity and allows multiple sers to share at least one needs descriptions determined by said physical entity comprising:
an identification information obtaining procedure that obtains sufficient information for recognizing and identifying a physical entity;
a needs association procedure that associates at least one needs description with identification information of a physical entity;
an information association procedure that associates at least one information description with a needs description;
a needs display procedure that displays at least one needs description associated with a physical entity; and
an information display procedure that displays at least one information description associated with a needs description.

2. The system of claim 1, wherein a needs description that is associated by said procedure for associating needs is created by using at least one of a procedure for creating from scratch, a procedure for copying an existing needs object, and a procedure for modifying an existing needs object.

3. The system of claim 1, wherein an information description that is associated by said procedure for associating information is created by using at least one of a procedure for creating from scratch, a procedure for copying an existing information object, and a procedure for modifying an existing information object.

4. The system of claim 1, further comprising a direct information association procedure that associates at least one information description with said physical entity and a direst information display procedure that that displays an information description associated with said physical entity by a direct information association procedure.

5. The system of claim 1, wherein the content of a needs description is described by using at least one of natural languages, database query languages, XML (Extensible Markup Language) query languages and information retrieval query languages.

6. The system of claim 1, further comprising at least one mobile device or at least one personal computer that has a memory space for storing identification information of at least one physical entity or a data structure that references identification information of at least one physical entity.

7. The system of claim 1, further comprising a notification procedure that notifies at least one user when at least one needs description or information description is created.

8. The system of claim 1, wherein said identification information obtaining procedure utilizes at least one of a barcode scanner, a radio frequency identification (RFID) reader, a scanner, an infrared signal reader, a client device of an embedded Web server, an electromagnetic induction sensor, an electrostatic induction sensor, a ultrasound sensor, a microchip reader, a magnetic card reader, a biometrics information reader, an image recognition device, the global positioning system (GPS), a device that identifies a service area using access points of wireless communications, a real time locating system (RTLS), and a manual input procedure of identification information.

9. The system of claim 1, further comprising an automatic information gathering procedure that generates executable instructions for information sources on the network and for information sources on each mobile device or computer from a needs description and collects information descriptions related to said needs description from the execution result of said instructions.

10. A method that allows multiple users to share information needs using physical entities comprising:
presenting to a mobile device or a computer a physical entity with which at least one needs description is associated;
recognizing said presented physical entity and obtaining sufficient information for identifying the physical entity;
creating at least one needs description and associating the needs description with the identification information of said physical entity;
creating at least one information description and associating the information description with at least one needs description that is associated with the identification information of said physical entity;
displaying at least one needs description associated with the identification information of said physical entity; and
displaying at least one information description associated with at least one needs description that is associated with the identification information of said physical entity.

11. The method of claim 10, wherein a needs description is created by creating from scratch, copying an existing needs object, or modifying an existing needs object.

12. The method of claim 10, wherein an information description is created by creating from scratch, copying an existing information object, or modifying an existing information object.

13. The method of claim 10, further comprising creating at least one information description, directly associating the at least one information description with the identification information of said physical entity, and displaying at least one information description that is directly associated with the identification information of said physical entity.

14. The method of claim 10, wherein the content of a needs description is described by using at least one of natural languages, database query languages, XML (Extensible Markup Language) query languages and information retrieval query languages.

15. The method of claim 10, further comprising selecting the identification information or information associated with the identification information of said physical entity, which is stored on said mobile device or said personal computer, and obtaining information that is sufficient for identifying said physical entity even when it is impossible to present said physical entity to said mobile device or said personal computer.

16. The method of claim 10, further comprising notifying at least one user when at least one needs description or information description is created.

17. The method of claim 10, wherein said presented physical entity is recognized by using at least one of a barcode scanner, a radio frequency identification (RFID) reader, a scanner, an infrared signal reader, a client device of an embedded Web server, an electromagnetic induction sensor, an electrostatic induction sensor, a ultrasound sensor, a microchip reader, a magnetic card reader, a biometrics information reader, an image recognition device, the global positioning system (GPS), a device that identifies a service area using access points of wireless communications, a real time locating system (RTLS), and a manual input procedure of identification information.

18. The method of claim 10, further comprising automatically gathering information descriptions related to said needs description form information sources on the network and from information sources on each mobile device or computer after said needs object is created. can actually manipulate the radio cassette player at hand than when the customers are only provided with a low quality picture of said radio cassette player on a home page.
